(19) United States
(12) Patent Application Publication
(10) Pub. No.: US 2006/0018047 A1
(43) Pub. Date: Jan. 26, 2006

(54) Electromagnetic radiation assembly

(76) Inventors: Daniel R. Todd, Sheboygan, WI (US); Daniel J. Mathieu, Sheboygan Falls, WI (US); Allen A. Bukosky, Sheboygan, WI (US)

Correspondence Address: WELLS ST. JOHN P.S., 601 W. FIRST AVENUE, SUITE 1300, SPOKANE, WA, 99201, US

(21) Appl. No.: 10/899,685

(22) Filed: Jul. 26, 2004

(51) Int. Cl. G02B 5/08

(52) U.S. Cl. 359/844

(57) ABSTRACT

An electromagnetic radiation assembly is disclosed and which includes a circuit substrate having a first portion and a flexible second portion, and wherein the circuit substrate defines at least one electrical pathway; a first electromagnetic radiation emitter is electrically coupled to the electrical pathway and located on the first portion of the circuit substrate; and a second electromagnetic radiation emitter is electrically coupled to the electrical pathway and located on the second portion of the circuit substrate.

### TECHNICAL FIELD

The present invention relates to an electromagnetic radiation assembly which finds usefulness when installed on overland vehicles, and more particularly to an electromagnetic radiation assembly which when coupled with the controls of an overland vehicle may operate as a combined warning lamp and rear view mirror assembly, and which further provides a visibly discernible signal which can be viewed from a wide range of locations not possible heretofore.

### BACKGROUND OF THE INVENTION

The beneficial effects of employing auxiliary signaling or electromagnetic radiation assemblies have been disclosed in various U.S. patents including U.S. Pat. Nos. 5,014,167; 5,207,492; 5,355,284; 5,361,190; 5,481,409; 5,499,169; 5,528,422; 6,005,724; and 6,257,746 all of which are incorporated by reference herein. The assemblies disclosed in some of these patents teach the use of various dichroic mirrors which are operable to reflect a broad band of electromagnetic radiation, within the visible light portion of the spectrum, while simultaneously permitting electromagnetic radiation having wavelengths which reside within a predetermined spectral band to pass therethrough. As disclosed in these earlier prior art patents, these same dichroic mirrors remain an excellent visual image reflector, that is, achieving luminous reflectance which is acceptable for automotive, and other industrial applications, while simultaneously achieving an average transmittance in the predetermined spectral band which is suitable for use as a visual signal at a wide range of distances, and for various purposes.

While all of these prior art devices have worked with some degree of success, various shortcomings have been uncovered which have detracted from their wide spread use. Among the several shortcomings which have impeded commercial introduction has been the manufacturing costs associated with applying the rather complex optical coatings which are necessary to form the dichroic mirrors that are employed in these devices.

Still further, other devices have been introduced which diverge, to some degree, from the use of dichroic mirrors. These devices however, when built in accordance with their teachings, have been unable to provide the same performance characteristics as provided by the prior art which employs dichroic mirrors. Still further, other prior art references have described devices which attempt to provide the same functional benefits as described in these earlier patents. These references describe all manner of mirror housing modifications, where for example, lamps are located in various orientations to project light into predetermined areas both internally and/or beside the overland vehicle and to further provide auxiliary signaling or warning capability. Examples of these patents include U.S. Pat. Nos. 4,583,155; 4,646,210; 4,916,430; 5,059,015; 5,303,130; 5,371,659; 5,402,103; 5,497,306; and 5,436,741 to name but a few.

In addition to the shortcomings associated with fabricating a suitable dichroic coating for use in mirror assemblies as described in the prior art, the associated mirror housings have decreased in volume as a result of recent automotive platform design changes. Consequently, the amount of internal space which is available when these same housings are employed is quite limited. Therefore, the size and weight of an enclosed light, signaling or electromagnetic radiation emitting assembly employed in such devices has become a significant factor in the development and commercial introduction of a suitable product. Yet further, in view of these space limitations providing electrical power to the mirror housing for energizing motorized bezels; heaters and various lamps has become increasingly difficult because the prior art wire harnesses take up additional space in these mirror housings. One possible solution to this difficulty is found in U.S. patent application Ser. No. 10/355,915 and which was filed on Jan. 28, 2003. The teachings of this pending application is also incorporated by reference herein.

To address these and other perceived shortcomings in the prior art, U.S. Pat. No. 6,005,724 disclosed a novel mirror assembly which employed a mirror substrate which is fabricated by using conventional techniques, and which includes a primary mirror surface region which reflects less than about 80% of a given band of visibly discernable electromagnetic radiation; and a secondary region adjacent thereto and through which electromagnetic radiation may pass. In mirrors of this design, the average reflection of the mirror coating is greater than about 50%. This novel invention resulted in significant decreases in the manufacturing costs for devices of this type. Still further, the perceived safety advantages of using such auxiliary signaling devices has now been well established, inasmuch as these same signaling assemblies provide a convenient means whereby an operator may signal vehicles which are adjacent to, and rearwardly oriented relative to an overland vehicle equipped with same, of their intention, for example, to change lanes, turn, or perform other vehicle maneuvers which would be of interest to vehicles traveling adjacent thereto.

An electromagnetic radiation assembly which achieves these and other advantages is the subject matter of the present application.

### SUMMARY OF THE INVENTION

Therefore one aspect of the present invention relates to an electromagnetic radiation assembly which includes a circuit substrate having a first portion, and a flexible second portion, and wherein the circuit substrate defines at least one electrical pathway; a first electromagnetic radiation emitter electrically coupled to the electrical pathway and located on the first portion of the circuit substrate; and a second electromagnetic radiation emitter electrically coupled to the electrical pathway and located on the second portion of the circuit substrate.

Another aspect of the present invention relates to an electromagnetic radiation assembly which includes a housing defined by a sidewall; a semitransparent mirror borne by the housing, and having a first region which passes visibly discernible electromagnetic radiation, and a second region which is adjacent thereto; an electrical pathway borne by the semitransparent mirror; a first electromagnetic radiation emitter electrically coupled to the electrical pathway, and positioned adjacent to the first region, and which, when energized, emits electromagnetic radiation which is passed, at least in part, by the first region, and in a first direction; and a second electromagnetic radiation emitter electrically coupled to the electrical pathway, and which, when energized, emits electromagnetic radiation which passes through the sidewall of the housing and in a second direction.

Yet still further, another aspect of the present invention relates to an electromagnetic radiation assembly which includes a housing having a sidewall, and which defines a cavity, and wherein the sidewall further defines an aperture; a translucent lens positioned in substantially occluding relation relative to the aperture; a semitransparent mirror borne by the housing, and which has an outwardly facing surface, and an inwardly facing surface which defines, at least in part, the cavity of the housing, and wherein the semitransparent mirror has a first region which passes visibly discernible electromagnetic radiation, and a second region, which is adjacent thereto; an electrically insulative circuit substrate having a first portion which is juxtaposed relative to the inside facing surface of the semitransparent mirror, and a second portion which is positioned, at least in part, near the translucent lens; a first electrical pathway borne by the circuit substrate, and which is selectively electrically coupled to a source of electrical power; a first electromagnetic radiation emitter borne by the first portion of the circuit substrate, and which is electrically coupled with the first electrical pathway, and wherein the first electromagnetic radiation emitter, when energized, emits visibly discernable electromagnetic radiation which passes through the first region of the semitransparent mirror; a second electromagnetic radiation emitter borne by the second portion of the circuit substrate, and which is electrically coupled to first electrical pathway, and wherein the second electromagnetic radiation emitter, when energized, emits visibly discernible electromagnetic radiation which is passed by the translucent lens; and a reflector disposed in eccentric covering reflecting relation relative to the first electromagnetic radiation emitter, and which reflects the visibly discernable electromagnetic radiation emitted by the first electromagnetic radiation emitter through the first region of the semitransparent mirror.

These and other aspects of the present invention will be discussed in greater detail hereinafter.

### BRIEF DESCRIPTION OF THE DRAWINGS

Preferred embodiments of the invention are described below with reference to the following accompanying drawings.

FIG. 1 is a greatly enlarged, fragmentary, substantially horizontal sectional view of one form of the electromagnetic radiation assembly of the present invention.

FIG. 2 is a fragmentary, plan view of a circuit substrate which is utilized in the electromagnetic radiation assembly of the present invention.

FIG. 3 is a greatly exaggerated, partial, vertical sectional view of the electromagnetic radiation assembly of the present invention, and which is taken from a position along line 3-3 in FIG. 1.

FIG. 4 is a greatly enlarged, partial, vertical sectional view of a second form of the electromagnetic radiation assembly of the present invention, and which is taken from a position along line 3-3 in FIG. 1, and which illustrates an alternative form of the invention from that shown in FIG. 3.

FIG. 5 is a greatly enlarged, partial, vertical sectional view of yet another form of the electromagnetic radiation assembly of the present invention, and which is further different from that shown in FIGS. 3 and 4.

FIG. 6 shows a greatly enlarged, vertical sectional view of a prior art electrochromic mirror assembly and which may utilize the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

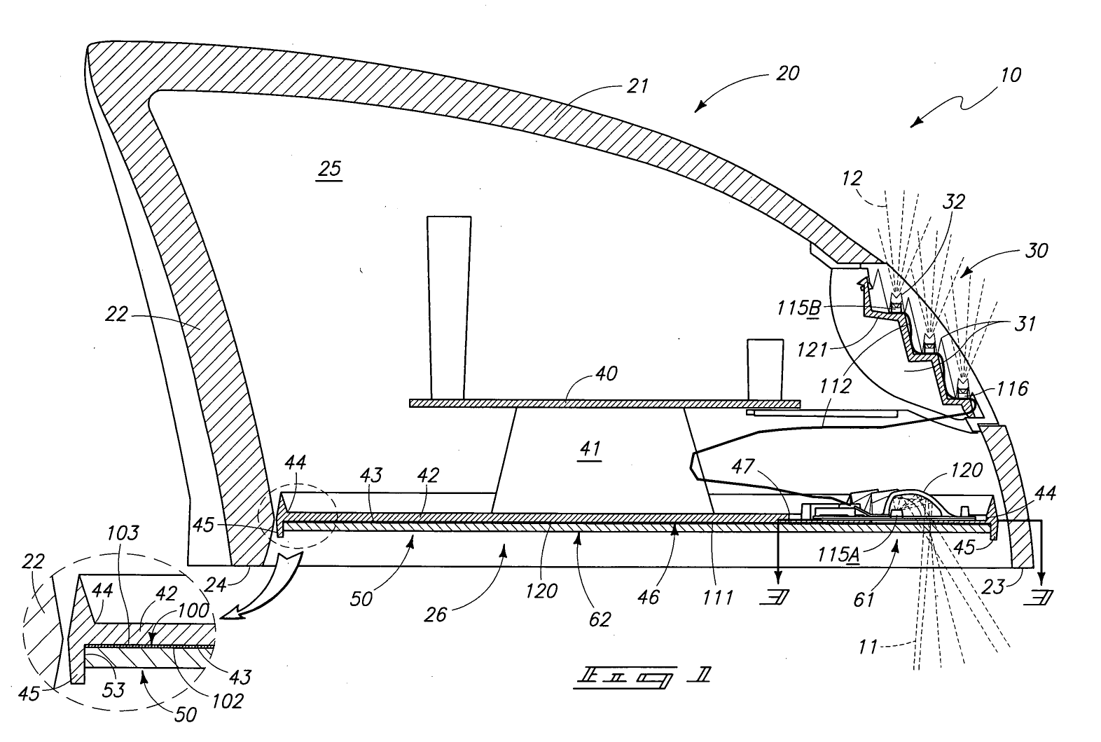

Referring more particularly to the drawings, an electromagnetic radiation assembly of the present invention is generally indicated by the numeral 10 in FIG. 1. For illustrative convenience, the electromagnetic radiation assembly 10 of the present invention, and which is shown and described herein, is discussed as it would be configured if it was installed on an overland vehicle (not shown) of conventional design. As discussed in many of the earlier prior art references, which are incorporated by reference herein, the electromagnetic radiation assembly (hereinafter referred to as assembly 10) of the present invention is adapted to operate as a combination rear-view mirror and visual signaling device, and wherein the visual signaling device provides a visual signal which is capable of being seen from locations which are laterally and rearwardly disposed relative to the overland vehicle when the invention is operating in a first mode which is generally indicated by the numeral 11. During this first mode of operation, the visual signal, at a significantly reduced luminous intensity can normally be seen by the operator of the vehicle. Still further, the invention 10, when operating in a second mode or operation, which is generally indicated by the numeral 12, produces a visibly discernable signal which can be seen generally laterally and forwardly relative to the intended direction of movement of the overland vehicle. These first and second modes of operation 11 and 12 will be discussed in greater detail hereinafter.

Referring still to FIG. 1, the assembly 10 includes a mirror housing which is generally indicated by the numeral 20. The mirror housing includes a first, convexly curved sidewall 21, and a second sidewall 22, which is made integral with same. The first and second sidewalls each include a peripheral edge 23 and 24, respectively. The sidewalls define an internal cavity 25, and a mirror opening which is generally indicated by the numeral 26. In addition to the foregoing, it will be seen in FIG. 1 that the first convexly curved sidewall 21 defines an aperture which is indicated by the numeral 30. A translucent lens 31 is provided, and which is operable to substantially occlude the aperture 30. The translucent lens 31 has a number of pockets or facets 32 which direct emitted visibly discernable electromagnetic radiation in a given pattern, and direction and which is different from that pattern of light which is emitted when the assembly 10 is operating in a first mode 11. This is seen in FIG. 1. The translucent lens 31 may be formed in a number of different colors and is operable to occlude the aperture and is secured to the housing 20 in the manner of a snap-fit as illustrated in FIG. 1.

Referring still to FIG. 1, it will be seen that the assembly 10 includes a motor mount which is generally indicated by the numeral 40, and which is positioned or is otherwise fastened in a fixed location within the cavity 25 of the mirror housing 20. A motor, of traditional design 41 is generally shown and is mounted on the motor mount 40 and is operable to move or otherwise orient a bezel 42 in various orientations in substantially occluding relation relative to the mirror opening 26. The bezel 42 has a mounting surface 43, which is generally considered the forward facing surface of same even though it is facing generally rearwardly with respect to the vehicle. The bezel 42 is defined by a peripheral edge 44. A sidewall 45 extends generally normally outwardly relative to the peripheral edge and defines a region 46 which will securably receive a semitransparent mirror as will be described below. Still further, an aperture 47 is defined in the bezel 42, and is useful for the purposes which will be described hereinafter. As seen in FIG. 1, the peripheral edge 44 is positioned in spaced relation relative to the sidewall 22. Therefore, the cavity 25 communicates with the surrounding ambient environment. In view of this, fine particulate matter, such as dust and dirt from the ambient environment, may find its way in the cavity 25 and coat the surfaces and other structures enclosed in the mirror housing 20. Aspects of the present invention, which will be disclosed below, substantially prevent this from occurring with respect to the translucent lens 31.

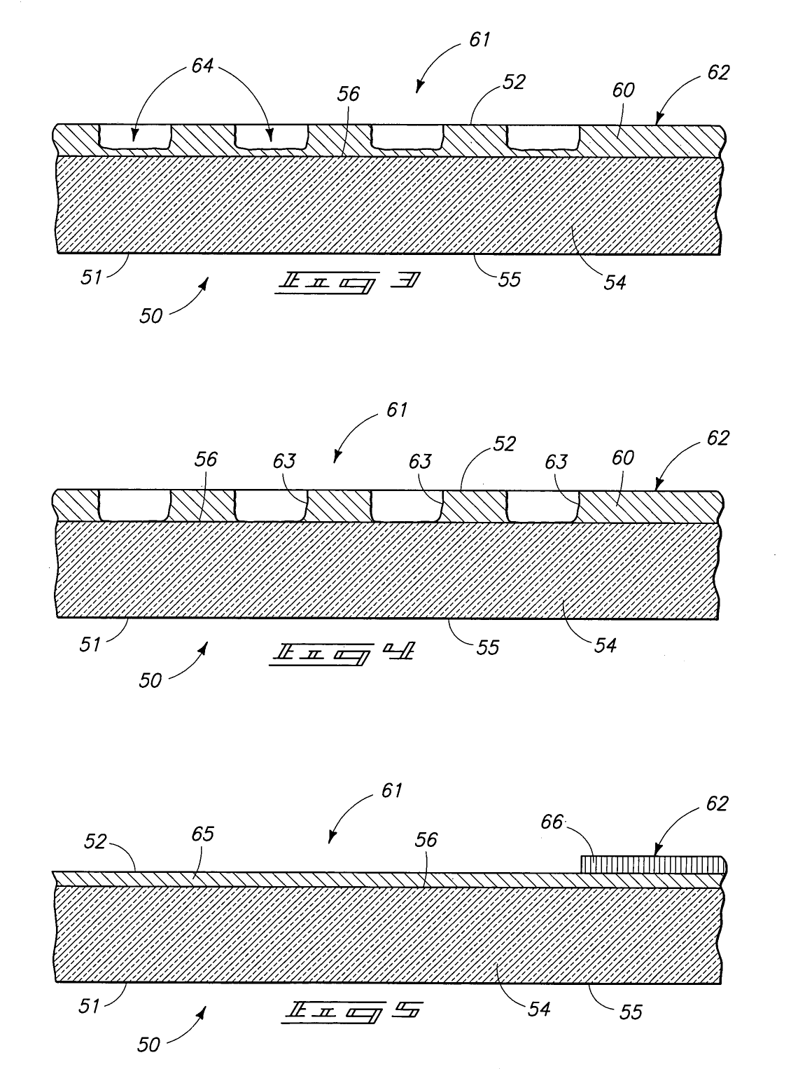

The assembly 10 of the present invention as shown in FIG. 1 includes a semitransparent mirror which is generally indicated by the numeral 50. Referring now to FIG. 3-6, the semitransparent mirror has an exterior facing surface 51, and an opposite inwardly facing surface 52. Like the bezel 42, the outer surface of the semitransparent mirror 50 is generally considered the forwardly facing surface of same even though it is facing generally rearwardly with respect to the vehicle. Similarly, the inwardly facing surface is considered the rearward facing surface of same even though it is facing generally forwardly relative to the vehicle upon which it is mounted. The semitransparent mirror further is defined by a peripheral edge 53 which substantially corresponds in shape and size to the mirror opening 26 as defined by the mirror housing 20 and is further engaged by the sidewall 45 of the mirror bezel 42. When assembled, the semitransparent mirror 50 substantially occludes the mirror opening 26. The semitransparent mirror 50 of the subject invention 10 may take on several forms as seen in FIGS. 3-6 respectively. In this regard, the semitransparent mirror 50 may comprise, in a first form, a supporting substantially transparent or translucent substrate 54 which has a forward facing surface 55, and an opposite rearwardly facing surface 56 as seen in FIG. 4. A highly reflective mirror coating 60 is formed, on the rearward facing surface 56. As should be understood, the mirror coating 60 may be applied, in an alternative form to the forward facing surface of the substrate 54. The discussion which follows, therefore, is applicable to semitransparent mirrors where the mirror coating is applied to either the forward or rearward facing surfaces thereof. The highly reflective mirror coating 60 may comprise any number of different highly reflective or mirror-like coatings or substances such as chromium, and the like, and which may be applied or formed in a manner which provides a commercially acceptable reflective surface. For automotive applications, the resulting reflectance of the semitransparent mirror 50 should generally be on average greater than about 35%.

As seen in FIGS. 3-5, the semitransparent mirror 50 has a first or primary region 61, and through which a visibly discernable electromagnetic radiation signal may pass. Still further, the semitransparent mirror has an adjacent secondary region 62. While only two regions are shown and discussed herein, it is of course possible to have a plurality of primary and secondary regions depending upon the end use of the assembly 10. As a general matter, however, the first or primary region 61 passes a portion of the visibly discernable electromagnetic radiation directed at same, while simultaneously reflecting a given percentage of the visibly discernable electromagnetic radiation which comes from the ambient environment. On the other hand, the secondary region is operable to reflect visibly discernable electromagnetic radiation, and is otherwise considered substantially opaque. As discussed above, the combined average reflectance of the overall surface area of the semitransparent mirror 50 including both the primary and secondary regions 61 and 62, is normally greater than about 35% when the assembly 10 is employed for automotive applications. In other industrial applications, the average reflectance may be lower or higher depending upon the desired end use. As seen in the drawings, the secondary region 62 is substantially continuous and reflects, for automotive applications, greater than about 35% of visibly discernable electromagnetic radiation, and passes less than about 10% of visibly discernable electromagnetic radiation. The first or primary region 61, on the other hand passes less than about 50% of visibly discernable electromagnetic radiation and further reflects, on average, less than about 40% of visibly discernable electromagnetic radiation. The ranges noted above have been found suitable for automotive applications, however, it will be recognized that other broadened or narrower ranges may be useful for other industrial applications.

As seen in FIG. 4, in a first form of the invention, the mirror coating 60, and more specifically the first or primary region 61, of the semitransparent mirror 50, includes a plurality of discreet apertures 63, and which may be formed in a number of given patterns, and in various densities. As recognized by a study of FIG. 4, which is greatly exaggerated, the plurality of discreet apertures extend in this form of the invention through the mirror coating 60 to the rearward facing surface 56 of the transparent substrate 54. In an alternative form of the invention, and as shown in FIG. 3, reduced thickness areas 64 will be formed in the mirror coating 60. These reduced thickness areas have been termed “thin chrome” in the art and are further described more fully in U.S. Pat. No. 6,005,724, the teachings of which are incorporated herein. These reduced thickness areas allow increased amounts of visibly discernable electromagnetic radiation to pass therethrough in relative comparison to the adjacent thicker areas in the secondary region 62. Therefore, the secondary region 62 has a first thickness dimension for the mirror coating 60, which is greater than the thickness dimension of the mirror coating 60 which defines the first or primary region 61. Still further, these two approaches may be combined and wherein the apertures 63 may be joined or placed adjacent to a reduced thickness area 64.

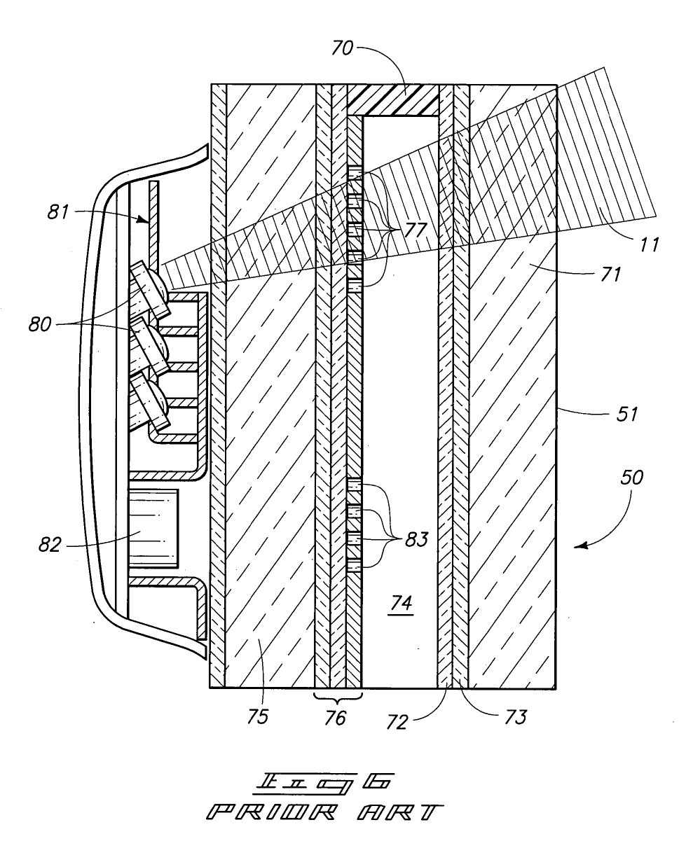

Referring now to FIG. 5, another form of a semitransparent mirror 50 is shown, and which is useful in the present invention. In this form of the invention, the substrate 54 has applied thereto a dichroic mirror coating 65. The usefulness of dichroic mirrors of various types have been discussed in various U.S. patents including U.S. Pat. Nos. 5,014,167 and 5,207,492 to name but a few. The dichroic mirror coatings 65 which are useful for such mirrors are also well known in the art, and further discussion regarding these dichroic mirror coatings is not warranted. As seen in FIG. 5 a substantially opaque masking layer 66 is applied over the secondary region 62 thereby making the secondary region substantially opaque. Visibly discernable electromagnetic radiation is passed through the first or primary region 61, which remains unmasked. As discussed in the earlier prior art patents, the dichroic mirror coating 65 may be selected to pass given bands of visibly discernable electromagnetic radiation in greater amounts than other bands of electromagnetic radiation, thereby making the resulting semitransparent mirror 50, on average, an acceptable reflector of visibly discernable electromagnetic radiation while simultaneously allowing increased amounts of electromagnetic radiation of the selected band of electromagnetic radiation to pass therethrough.

In yet another form of the invention an acceptable semitransparent mirror 50 which may be employed in the present invention 10 is seen in FIG. 6, and which illustrates a prior art arrangement for a signaling assembly which utilizes an electrochromic mirror 70. The electrochromic mirror 70 includes a front or transparent element or substrate 71 and further has applied to its rearwardly facing surface a transparent electrically conductive material 72 and a layer of color suppression material which is generally indicated by the numeral 73. In the arrangement as shown in FIG. 6, and electrochromic fluid or gel 74 is provided and which is sandwiched between the front element 71 and a rear element 75 which is also transparent. As seen in FIG. 6, a conductive thin film reflector/electrode 76 is positioned in spaced relation relative to the front element 71. Still further, a plurality of apertures 77 are formed in this conductive thin film/electrode 77 and which permit the passage of visibly discernable electromagnetic radiation to pass therethrough, and which forms a visibly discernable signal, as might be formed during the first mode of operation 11 of the present invention. As seen in FIG. 6, an electromagnetic radiation emitter, or light source 80 is provided, and which is disposed at an oblique orientation relative to the electrochromic mirror 70. Still further, a light baffle assembly 81 is provided and which is substantially identical to that described in our previous U.S. Pat. No. 6,257,746, the teachings of which are incorporated by reference herein. The light baffle assembly directs visibly discernable electromagnetic radiation to strike the electrochromic mirror 70 in a given orientation such that it can be transmitted into a given illumination zone during the first mode of operation 11. A light sensor 82 is provided and which is oriented in a fashion so as to receive ambient electromagnetic radiation passing through the apertures 83 which are formed in the thin film reflector/electrode 76, thereby allowing for the automatic adjustment of the reflectance of the electrochromic mirror 70. This prior art arrangement is discussed in further detail in U.S. Pat. No. 6,512,624 the teachings of which are incorporated by reference herein. As will be appreciated by a study of FIG. 6, the electrochromic mirror 70, as shown herein, may be useful in the practice of the invention as will be discussed in greater detail below.

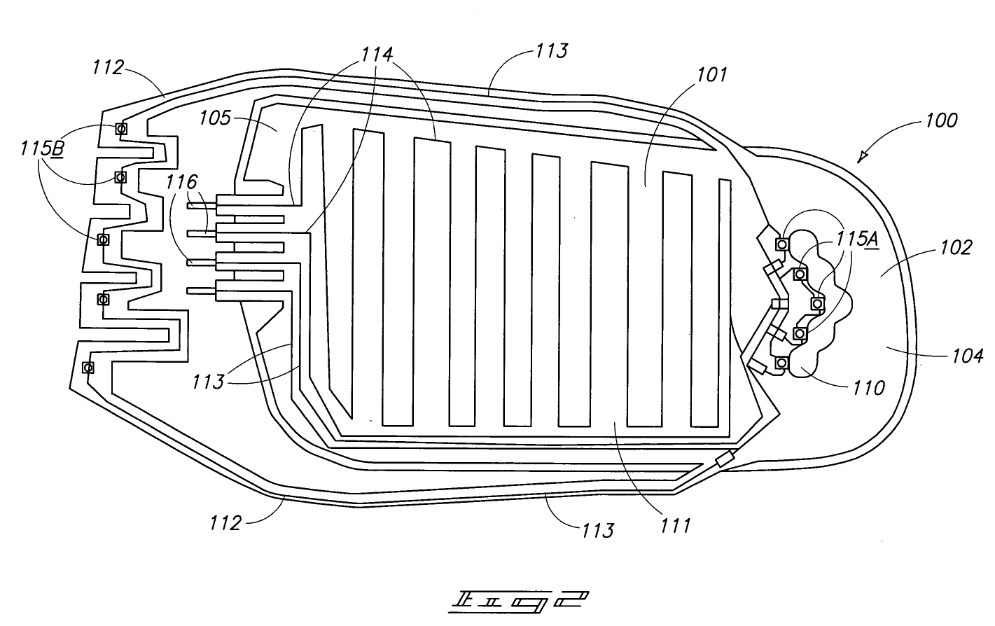

The electromagnetic radiation assembly 10 of the present invention includes a circuit substrate 100 which is best seen by references to FIGS. 1 and 2, respectively. As seen in FIG. 2, the circuit substrate which is positioned in juxtaposed relation relative to the rear surface 52 of the semitransparent mirror 50, has a main body 101 with a first surface 102 and an opposite second surface 103. The circuit substrate is fabricated from a substantially electrically non-conductive material which is flexible, and which substantially conforms to the topography and or shape of the rearwardly facing surface 52 of the semitransparent mirror 50. The circuit substrate has a first end 104 and an opposite second end 105. As seen in FIG. 2, the main body 101 has a region or aperture 110 formed near the first end 104 and which is operable to pass visibly discernable electromagnetic radiation therethrough. In an alternative form of the invention, the region 110 may comprise a transparent or translucent substrate. As best understood by a study of FIG. 1, this region 110 is substantially coaxially aligned relative to the region 61 as more fully seen in FIGS. 3-5, respectively. As seen in FIG. 2, the circuit substrate 100 includes a first portion 111 which lies in juxtaposed relation relative to the rear surface 52 and in substantially covering relation relative to the second region 62 of the semitransparent mirror 50. Further, the circuit substrate includes a second, flexible portion 112 which can be bent or otherwise deformed as seen in FIG. 1 in order to place the distal end thereof in an appropriate orientation relative to the translucent lens 31 and which is positioned in substantially occluding relation relative to the aperture 30. A first electrical pathway 113 is formed on the first and second portions 111 and 112, respectively. Still further, a second electrical pathway 114 is formed solely on the first portion 111. As seen in FIG. 2, a first plurality of electromagnetic radiation emitters 115A are mounted on the first portion 111 of the circuit substrate 100 and positioned adjacent to the region or aperture 110 which is operable to pass visibly discernable electromagnetic radiation. Still further, a second plurality of electromagnetic radiation emitters 115B are mounted on the distal end of the second portion 112. Each of the electromagnetic radiation emitters 115A and B are individually electrically coupled to the first electrical pathway 113. A plurality of electrical contacts 116 are individually electrically coupled to the first and second electrical pathways 113 and 114 to provide a means by which an external source of electricity (not shown) may be selectively supplied to the first and second electrical pathways for the purposes which will be described in the paragraphs below. The second portion 112 of the circuit substrate is sized and shaped such that when it is installed, as seen in FIG. 1, it may, in some forms of the invention, substantially occlude the aperture 30, and thereby prevents dust, grime, or road dirt which has found its way into the housing cavity 25, from coating the inside facing surface of the translucent lens 31, and preventing the passage of visibly discernable electromagnetic radiation therethrough. Still further, in other forms of the invention, the second portion 112 of the circuit substrate may only partially occlude the aperture 30. Additionally, the second portion of the circuit substrate 112 is typically substantially opaque and therefore impedes the passage of visibly discernable electromagnetic radiation therethrough. This feature of the invention substantially prevents ambient visibly discernable electromagnetic radiation which has passed into the mirror housing 20 from a location either in front of, or rearwardly of the mirror housing from exiting the housing and potentially being misinterpreted by an adjacent observer (not shown) as a visible signal emitted by the apparatus 10. In the alternative, this feature of the invention substantially prevents visibly discernable electromagnetic radiation emitted by the respective electromagnetic radiation emitters 115A and B from entering into the housing cavity 25. Additionally, and while discrete electromagnetic radiation emitters 1115A and B are shown and electrically coupled to the circuit substrate 100, it will be recognized that discrete circuit boards as well as other electrically actuated assemblies (not shown), could also be electrically coupled with same and which could achieve the benefits of the present invention.

As seen in FIG. 1, the electromagnetic radiation assembly 10 of the present invention further includes a reflector 120 which is disposed in substantially covering, eccentric reflecting relation relative to the electromagnetic radiation emitters 115A which are positioned near the first end of the circuit substrate 100. When energized, these electromagnetic radiation emitters emit visibly discernable electromagnetic radiation which is reflected by the reflector 120 and which passes through the region 110 of the first portion 111 of the circuit substrate 100. In the first mode of operation 11 as seen in FIG. 1, this visibly discernable electromagnetic radiation forms a visibly discernable signal which can be seen substantially laterally and rearwardly relative to an overland vehicle upon which this device is positioned. In addition to the foregoing, when electrical energy is supplied to the first electrical pathway 113 to energize the electromagnetic radiation emitters 115A positioned near the first end 104 of the circuit substrate 100, this same electrical energy is also supplied to the electromagnetic radiation emitters 115B which are positioned on the second portion 112 of the circuit substrate. As seen in FIG. 1, these electromagnetic radiation emitters 115B are positioned so as to emit visibly discernable electromagnetic radiation which is directed towards the lens 30 which is positioned in substantially occluding relation relative to the aperture 30 which is formed in the sidewall 21. Therefore, as will be seen, providing electrical power to the first electrical pathway 113 has the effect of forming a visibly discernable electromagnetic radiation signal which can be seen both laterally, and forwardly and rearwardly relative to the mirror housing 20 in the first and second modes of operation 11 and 12, respectively. As seen in FIG. 1, a mounting bracket which is generally indicated by the numeral 121, is operable to releasably engage the second portion 112, of the circuit substrate 100 and thereby releasably mounts the electromagnetic radiation emitters 115B which are positioned on the second portion 112 in an orientation such that the emitted electromagnetic radiation provided by these same electromagnetic radiation emitters 115B passes through the aperture 30 and associated translucent lens 32. The mounting bracket 121 is sized and shaped such that it substantially occludes the aperture 30, and substantially prevents dust, grime, or dirt which may have entered into the housing cavity 25 from being deposited on the translucent lens 31. The mounting bracket is typically opaque, and is therefore operable to impeded visible light from entering into the housing cavity 25. In an alternative embodiment, not shown, the second portion 112 of the circuit substrate may be secured in an appropriate orientation by means of various welding techniques, or by the use of adhesives or the like. In the embodiment of the invention as shown in FIG. 2, it will be recognized that the second electrical pathway 114, and which is formed on the flexible electrically insulative circuit substrate 100 defines a heater which, when energized imparts heat energy to the second region 62 of the semitransparent mirror 50 which is juxtaposed thereto. In yet another form of the invention, a third electrically conductive pathway (not shown) could be formed on the circuit substrate and which could be electrically coupled to the electrochromic mirror 70 as seen in FIG. 6. As should be understood, the selective energizing of this third electrically conductive pathway would have the effect of changing the relative reflectivity of the electrochromic mirror 70 making it more or less reflective depending upon ambient lighting conditions as detected by the sensor 82.

### Operation

The operation of the described embodiment of the present invention is believed to be readily apparent and is briefly summarized at this point.

Referring now to FIG. 1 and following, an assembly 10 of the present invention is seen, and which includes a circuit substrate 100 having a first portion 111, and a flexible second portion 112, and wherein the circuit substrate 100 defines at least one electrical pathway 113. A first electromagnetic radiation emitter 115A is electrically coupled to the at least one electrical pathway and is located on the first portion 111 of the circuit substrate; and a second electromagnetic radiation emitter 115B is electrically coupled to the at least one electrical pathway and is located on the second portion 112 of the circuit substrate 100. As discussed above, the at least one electrical pathway 113 is electrically coupled to a source of electricity by way of the pair of electrical contacts 116, and wherein delivery of electricity to the electrical pathway 113 causes each of the first and second electromagnetic radiation emitters 115A and B to become energized and emit visibly discernible electromagnetic radiation. In the arrangement as shown in FIG. 1, the at least one electrical pathway 113 may be arranged such that the delivery of electricity to the electrical pathway causes the respective electromagnetic radiation emitters 115A and B to be selectively energized. As seen in FIG. 2, a second electrical pathway 114 is borne by the circuit substrate 100. In this arrangement, a source of electricity is coupled to the second electrical pathway 114, and the energizing of the second electrical pathway causes heat energy to be generated, and which is imparted to the semitransparent mirror 50 which is juxtaposed relative thereto. As will be appreciated by a study of FIG. 6, an electromagnetic radiation assembly 10 of the present invention may include a semitransparent mirror 50 which includes an electrochromic fluid or gel 74. In this arrangement, and in one possible form of the invention, the second electrical pathway 114 which is borne by the first portion 111, would be arranged so as to be electrically coupled to the electrochromic fluid or gel. In the alternative, a third electrical pathway (not shown) could be formed on the circuit substrate 100 and be electrically coupled to the electrochromic mirror 70. In this arrangement, as discussed above, the assembly 10 would include a visibly discernable signal 11 and 12, a heater as formed by the electrically conductive pathway 114, and an electrical circuit (not shown) for controlling the reflectivity of the electrochromic mirror 70. In the arrangement as shown in FIG. 1, the first and second electrical pathways are coupled with a source of electricity (not shown) and may be selectively energized depending upon the operational conditions of the overland vehicle, or outside ambient conditions.

As was discussed earlier in this application, the semitransparent mirror 50 has a first region 61 which passes visibly discernible electromagnetic radiation, and a second region 62 which is adjacent thereto and which is substantially opaque, that is, it passes less than about 10% of visibly discernable light. As seen in FIG. 1, the first portion 111 of the circuit substrate 100 is juxtaposed relative to the semitransparent mirror 50, and the first electromagnetic radiation emitters 115A emit visibly discernable electromagnetic radiation which passes through the first region 61 of the semitransparent mirror 50. As seen in FIG. 1, a housing 20 is provided, and which supports the semitransparent mirror 50. The sidewall 21 defines a region 30 which passes visibly discernible electromagnetic radiation. As also seen in FIG. 1, the second portion 112 of the circuit substrate 100 is juxtaposed, at least in part, relative to the region of the sidewall 30 which passes visibly discernible electromagnetic radiation. In the arrangement as shown in FIGS. 1 and 2, the region or aperture 110 which passes visibly discernable electromagnetic radiation 11 and which is defined by the circuit substrate 100 may be substantially continuous and translucent, or on the other hand, may define a single aperture as seen in FIG. 2, and which is operable to pass visibly discernable electromagnetic radiation. This region or aperture 110 is substantially aligned with the first region 61 of the semitransparent mirror 50. In the arrangement as shown in FIG. 1, a reflector 120 is disposed in covering, eccentric reflecting relation relative to the first electromagnetic radiation emitters 115A and which are positioned at or near the first end 104 of the circuit substrate 100. When energized, these electromagnetic radiation emitters 115A emit visibly discernible electromagnetic radiation which is reflected by the reflector, and which passes through the region 110 of the first portion 111 of the circuit substrate 100 and which further passes visibly discernible electromagnetic radiation and thereafter through the first region 61 of the semitransparent mirror 50.

Therefore one aspect of the present invention relates to an electromagnetic radiation assembly 10 which includes a mirror housing 20 which is defined by a sidewall 21, and a semitransparent mirror 50 is borne by the housing, and has a first region 61 which passes visibly discernible electromagnetic radiation, and a second region 62 which is adjacent thereto. In the present form of the invention an electrical pathway 113 is borne by the semitransparent mirror 50, and a first electromagnetic radiation emitter 115A is electrically coupled to the electrical pathway 113 and positioned adjacent to the first region 61, and which, when energized, emits electromagnetic radiation which is passed, at least in part, by the first region 61, and in a first direction such as seen with respect to the first mode of operation 11. Still further, a second electromagnetic radiation emitter 115B is electrically coupled to the electrical pathway 113, and which, when energized, emits visibly discernable electromagnetic radiation which passes through the sidewall 21, of the housing 20, and in a second direction such as seen with respect to he second mode of operation 12. As earlier disclosed, the sidewall 21 defines an aperture 30, and further a translucent lens 32 is provided, and which substantially occludes the aperture defined by the sidewall. In the arrangement as shown in FIGS. 1 and 2, a second electrical pathway 114 is provided, and which is juxtaposed relative to the semitransparent mirror 50, and which when energized imparts heat energy to the semitransparent mirror 50.

Therefore, it will be seen in another aspect of the invention that an electromagnetic radiation assembly 10 includes a housing 20 having a sidewall 21 and which defines a cavity 25, and wherein the sidewall further defines an aperture 30. A translucent lens 31 is positioned in substantially occluding relation relative to the aperture 30. A semitransparent mirror 50 is borne by the housing 20 and which has an outwardly facing surface 51, and an inwardly facing surface 52 which defines at least in part the cavity 25 of the housing 20. The semitransparent mirror 50 has a first region 61 which passes visibly discernible electromagnetic radiation, and a second region 62 which is adjacent thereto and which is substantially opaque. An electrically insulative circuit substrate 100 is provided, and which has a first portion 111 which is juxtaposed relative to the inside facing surface 52 of the semitransparent mirror 50, and a second portion 112 which is positioned, at least in part, near the translucent lens 31. A first electrical pathway 113 is borne by the circuit substrate 100, and which is operable to be selectively electrically coupled to a source of electrical power. A first electromagnetic radiation emitter 115A is borne by a first portion 111 of the circuit substrate 100, and which is electrically coupled with the first electrical pathway, and wherein the first electromagnetic radiation emitter 115A, when energized, emits visibly discernable electromagnetic radiation which passes through the first region 61 of the semitransparent mirror 50. Yet further, a second electromagnetic radiation emitter 115B is borne by the second portion 112 of the circuit substrate 100, and which is electrically coupled to first electrical pathway 113. The second electromagnetic radiation emitter 115B, when energized, emits visibly discernible electromagnetic radiation which is passed by the translucent lens 31. Still further, a reflector 120 is disposed in substantially eccentric covering reflecting relation relative to the first electromagnetic radiation emitter 115A, and which reflects the visibly discernable electromagnetic radiation emitted by the first electromagnetic radiation emitter 115A through the first region 61 of the semitransparent mirror 50.

Therefore, it will be seen that the assembly 10 of the present invention provides a convenient means by which the shortcomings of the prior art devices or assemblies can be readily rectified, and which further provides an assembly which achieves additional benefits by providing a visual signal which can be seen through a wide range of locations relative to an overland vehicle, for example, upon which it is installed and which has not been possible heretofore.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I/We claim:

1. An electromagnetic radiation assembly, comprising:
a circuit substrate having a first portion and a flexible second portion, and wherein the circuit substrate defines at least one electrical pathway;
a first electromagnetic radiation emitter electrically coupled to the electrical pathway and located on the first portion of the circuit substrate; and
a second electromagnetic radiation emitter electrically coupled to the electrical pathway and located on the second portion of the circuit substrate.

2. An electromagnetic radiation assembly as claimed in claim 1, and wherein the electrical pathway is electrically coupled to a source of electricity, and wherein delivery of electricity to the electrical pathway causes each of the first and second electromagnetic radiation emitters to become energized and emit visibly discernible electromagnetic radiation.

3. An electromagnetic radiation assembly as claimed in claim 1, and wherein the electrical pathway is electrically coupled to a source of electricity, and wherein delivery of electricity to the electrical pathway causes the respective electromagnetic radiation emitters to be selectively energized.

4. An electromagnetic radiation assembly as claimed in claim 1, and further comprising:
a second electrical pathway borne by the circuit substrate, and wherein a source of electricity is coupled to the second electrical pathway, and wherein energizing the second electrical pathway causes heat energy to be generated.

5. An electromagnetic radiation assembly as claimed in claim 1, and further comprising:
a second electrical pathway borne by the first portion of the circuit substrate; and
an electrochromic fluid or gel electrically coupled to the circuit substrate, and wherein the second electrical pathway is coupled to a source of electricity, and wherein the selective energizing of the second electrical pathway causes the electrochromic fluid or gel to selectively pass predetermined amounts of visibly discernible electromagnetic radiation.

6. An electromagnetic radiation assembly as claimed in claim 1, and further comprising:
a second electrical pathway borne by the first portion of the circuit substrate, and
a second electrically actuatable assembly electrically coupled with the second electrical pathway, and wherein the first and second electrical pathways are coupled with a source of electricity and may be selectively energized.

7. An electromagnetic radiation assembly as claimed in claim 1, and further comprising:
a semitransparent mirror having a first region through which discernible electromagnetic radiation passes, and a second region adjacent thereto, and wherein the first portion of the circuit substrate is juxtaposed relative to the semitransparent mirror, and wherein the first electromagnetic radiation emitter emits electromagnetic radiation which passes through the first region of the semitransparent mirror.

8. An electromagnetic radiation assembly as claimed in claim 7, and further comprising:
a housing defined by a sidewall, and which supports the semitransparent mirror, and wherein the sidewall defines a region through which visibly discernible electromagnetic radiation passes, and wherein the second portion of the circuit substrate is juxtaposed relative to the region of the sidewall which passes visibly discernible electromagnetic radiation.

9. An electromagnetic radiation assembly as claimed in claim 8, and wherein the second portion of the circuit substrate is positioned adjacent to the sidewall through which the visibly discernable electromagnetic radiation passes by a mounting bracket which is substantially opaque and which further substantially impedes the deposit of particulate matter on the region of the sidewall which passes the visibly discernable electromagnetic radiation.

10. An electromagnetic radiation assembly as claimed in claim 8, and further comprising:
a second electrical pathway borne by the first portion of the circuit substrate, and wherein the second electrical pathway is coupled to a source of electricity and which, when energized, imparts heat energy to the semitransparent mirror.

11. An electromagnetic radiation assembly as claimed in claim 10, and wherein the semitransparent mirror has an exterior facing surface having a shape, and wherein the first portion of the circuit substrate substantially conforms to the shape of the exterior facing surface of the semitransparent mirror.

12. An electromagnetic radiation assembly as claimed in claim 1, and wherein the first portion of the circuit substrate includes a region through which visibly discernible electromagnetic radiation passes.

13. An electromagnetic radiation assembly as claimed in claim 12, and wherein the first electromagnetic radiation emitter emits electromagnetic radiation which passes through the region of the circuit substrate which passes the visibly discernible electromagnetic radiation.

14. An electromagnetic radiation assembly as claimed in claim 12, and wherein the region of the first portion of the circuit substrate through which visibly discernible electromagnetic radiation passes is substantially continuous, and translucent.

15. An electromagnetic radiation assembly as claimed in claim 12, and wherein the region of the first portion of the circuit substrate through which visibly discernible electromagnetic radiation passes is discontinuous, and defines at least one aperture which passes visibly discernible electromagnetic radiation.

16. An electromagnetic radiation assembly as claimed in claim 12, and further comprising:
a reflector disposed in covering, eccentric reflecting relation relative to the first electromagnetic radiation emitter, and wherein the first electromagnetic radiation emitter, when energized, emits visibly discernible electromagnetic radiation which is reflected by the reflector and which passes through the region of the first portion of the circuit substrate which passes visibly discernible electromagnetic radiation.

17. An electromagnetic radiation assembly comprising:
a housing which is defined by a sidewall;
a semitransparent mirror borne by the housing, and having a first region through which visibly discernible electromagnetic radiation passes, and a second region which is adjacent thereto;
an electrical pathway borne by the semitransparent mirror;
a first electromagnetic radiation emitter electrically coupled to the electrical pathway and positioned adjacent to the first region, and which, when energized, emits electromagnetic radiation which passes through, at least in part, the first region, and in a first direction; and
a second electromagnetic radiation emitter electrically coupled to the electrical pathway, and which, when energized, emits electromagnetic radiation which passes through the sidewall of the housing, and in a second direction.

18. An electromagnetic radiation assembly as claimed in claim 17, and wherein the sidewall defines an aperture, and wherein the electromagnetic radiation assembly further comprises a translucent lens which substantially occludes the aperture defined by the sidewall.

19. An electromagnetic radiation assembly as claimed in claim 18, and further comprising:
a mounting bracket, and wherein a portion of the electrical pathway, and the second electromagnetic radiation emitter are affixed to the mounting bracket, and wherein the mounting bracket releasably mounts the second electromagnetic radiation emitter on the housing and in an orientation such that the emitted electromagnetic radiation provided by the second electromagnetic radiation emitter passes through the aperture and translucent lens.

20. An electromagnetic radiation assembly as claimed in claim 19, and wherein the mounting bracket is sized so as to substantially occlude the aperture which is defined in the sidewall and which further substantially impedes the deposit of any particulate matter on the translucent lens.

21. An electromagnetic radiation assembly as claimed in claim 17, and further comprising:
a flexible electrically insulative substrate, and wherein the electrical pathway is formed on the flexible electrically insulative substrate, and wherein the flexible electrically insulative substrate is juxtaposed relative to the semitransparent mirror.

22. An electromagnetic radiation assembly as claimed in claim 21, and wherein the electrical pathway further defines a heater which, when energized, imparts heat energy to the semitransparent mirror.

23. An electromagnetic radiation assembly as claimed in claim 17, and wherein the semitransparent mirror includes a highly reflective mirror coating, and wherein a portion of the highly reflective mirror coating is removed to define the first region.

24. An electromagnetic radiation assembly as claimed in claim 17, and wherein the semitransparent mirror includes a dichroic mirror coating which is operable to pass emitted electromagnetic radiation having predetermined wavelengths and wherein the first electromagnetic radiation emitter emits electromagnetic radiation having the predetermined wavelengths which are passed by the semitransparent mirror.

25. An electromagnetic radiation assembly as claimed in claim 17, and wherein the semitransparent mirror has a highly reflective mirror coating, and wherein the first region of the semitransparent mirror has a mirror coating thickness having a first dimension, and wherein the second region of the semitransparent mirror has a mirror coating thickness having a second dimension, and wherein the second dimension is greater than the first dimension.

26. An electromagnetic radiation assembly as claimed in claim 17, and wherein the semitransparent mirror comprises an electrochromic mirror.

27. An electromagnetic radiation assembly as claimed in claim 17, and wherein the first and second electromagnetic radiation emitters emit electromagnetic radiation having substantially the same wavelengths of electromagnetic radiation.

28. An electromagnetic radiation assembly as claimed in claim 17, and wherein the first and/or second electromagnetic radiation emitters are mounted on discrete circuit boards, and wherein the discrete circuit boards are electrically coupled to the electrical pathway.

29. An electromagnetic radiation assembly as claimed in claim 17, and wherein the first and second electromagnetic radiation emitters emit electromagnetic radiation having different wavelengths.

30. An electromagnetic radiation assembly as claimed in claim 17, and further comprising:
a reflector disposed in covering eccentric reflecting relation relative to the first electromagnetic radiation emitter, and which reflects the emitted electromagnetic radiation produced by the first electromagnetic radiation emitter in the direction of the first region of the semitransparent mirror.

31. An electromagnetic radiation assembly comprising:
a housing having a sidewall and which defines a cavity, and wherein the sidewall further defines an aperture;
a translucent lens positioned in substantially occluding relation relative to the aperture;
a semitransparent mirror borne by the housing, and which has an outwardly facing surface, and an inwardly facing surface which defines, at least in part, the cavity of the housing, and wherein the semitransparent mirror defines a first region through which visibly discernible electromagnetic radiation passes, and a second region which is adjacent thereto;
a flexible, electrically insulative circuit substrate having a first portion which is juxtaposed relative to the inside facing surface of the semitransparent mirror, and a second portion which is positioned near the translucent lens;
a first electrical pathway borne by the circuit substrate, and which is operable to be selectively electrically coupled to a source of electrical power;
a first electromagnetic radiation emitter borne by the first portion of the circuit substrate, and which is electrically coupled with the first electrical pathway, and wherein the first electromagnetic radiation emitter, when energized, emits visibly discernable electromagnetic radiation which passes through the first region of the semitransparent mirror;
a second electromagnetic radiation emitter borne by the second portion of the circuit substrate, and which is electrically coupled to the first electrical pathway, and wherein the second electromagnetic radiation emitter, when energized, emits visibly discernible electromagnetic radiation which is passed by the translucent lens; and
a reflector disposed in eccentric, covering, reflecting relation relative to the first electromagnetic radiation emitter, and which reflects electromagnetic radiation emitted by the first electromagnetic radiation emitter in a direction towards the first region of the semitransparent mirror.

32. An electromagnetic radiation assembly as claimed in claim 31, and wherein a second electrical pathway is borne by the circuit substrate, and which, when energized, emits heat energy which is imparted to the second region of the semitransparent mirror.

33. An electromagnetic radiation assembly as claimed in claim 31, and wherein energizing the first electrical pathway causes the first and second electromagnetic radiation emitters to substantially simultaneously emit visibly discernible electromagnetic radiation.

34. An electromagnetic radiation assembly as claimed in claim 31, and further comprising:
a mounting bracket which releasably engages the sidewall of the housing, and wherein the second portion of the circuit substrate is engaged by the mounting bracket, and wherein the mounting bracket positions the second portion of the circuit substrate adjacent to the translucent lens, and substantially impedes the deposit of any particulate matter on the translucent lens.
